(19) United States
(12) Patent Application Publication
(10) Pub. No.: US 2008/0273767 A1
(43) Pub. Date: Nov. 6, 2008

(54) ITERATIVE PRINT MATCHING METHOD AND SYSTEM

(75) Inventors: PETER Z. LO, LAKE FOREST, CA (US); GUIPING YU, HAIDIAN DISTRICT (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/742,793

(22) Filed: May 1, 2007

(51) Int. Cl. G06K 9/00

(52) U.S. Cl. 382/124

(57) ABSTRACT

A print identification system performs the following: comparing a primary search print to each of a plurality of file print to generate a primary sorted match report having a first set of file IDs each associated with a first match score; applying a decision logic to the first match scores to determine a status of the corresponding file prints a strong match, a possible match or no match to the search print; for each file print identified as a strong match, compare that file print against file prints identified as a possible match or no match to generate a sub-match report including at least a portion of the first set of file IDs each associated with a second match score; and modifying the primary sorted match report based on at least one of the second match scores to generate a final sorted match report.

### CROSS-REFERENCE TO RELATED APPLICATIONS

The present application is related to the following U.S. application commonly owned together with this application by Motorola, Inc.:

Ser. No. 11/554,720, filed Oct. 31, 2006, titled “Print Matching Method and Apparatus Using Pseudo-Ridges by Lo, et al. (attorney docket no. CM09327G).

### TECHNICAL FIELD

The technical field relates generally to print identification systems and more particularly to iterative print matching using decision logic results.

### BACKGROUND

Identification pattern systems, such as ten prints or fingerprint identification systems, play a critical role in modern society in both criminal and civil applications. For example, criminal identification in public safety sectors is an integral part of any present day investigation. Similarly in civil applications such as credit card or personal identity fraud, print identification has become an essential part of the security process.

An automatic fingerprint identification operation normally consists of two stages. The first is the registration stage and the second is the identification stage. In the registration stage, the register's prints (as print images) and personal information are enrolled, and features, such as minutiae, core, delta, and classification type, are extracted. Classification type may be, for example, whorl, left loop, right loop, tented arch, and plain arch. Moreover, image quality at individual pixel locations or at blocks of pixels within the direction image can be determined using any suitable means, to facilitate implementations of various embodiments. An illustrative scale for image quality is from 0 in to 100 in, with 0 in being a lowest quality and 100 in being a highest quality. Direction images based on the print images may also be generated depending on the particular matching algorithm being implemented.

The personal information and the extracted features (and perhaps the print images and direction images) are then used to form a file record that is saved into a database for subsequent print identification. These features may be stored as a template with a standard exchangeable format. Moreover, since storage of a direction image (or other print image) in a regular format can use more storage space than is desirable for some implementations, the direction images may alternatively be quantized into a smaller range of values, and the direction images may further be compressed using any suitable image or data compression technique to minimize storage requirements. For example, the number of directions in a direction image may be quantized into M and the dimensionality of the direction image reduced to R×C from Rn×Cn for computational efficiency, wherein a block (of pixels) represents (Rn×Cn/R×C) pixels.

Present day automatic fingerprint identification systems (AFIS) may contain several hundred thousand to a few million of such file records. In the identification stage, print features from an individual, or latent print, and personal information are extracted to form what is typically referred to as a search record. The search record is then compared with the enrolled file records in the database of the fingerprint matching system. In a typical search scenario, a search record may be compared against millions of file records that are stored in the database and a list of match scores is generated after the matching process. Candidate records are sorted according to match scores. A match score is a measurement of the similarity of the print features of the identified search and file records. The higher the score, the more similar the file and search records are determined to be. Thus, a top candidate is the one that has the closest match.

However it is well known from verification tests that the top candidate may not always be the correctly matched record because the obtained print images may vary widely in quality. Smudges, individual differences in technique of the personnel who obtain the print images, equipment quality, and environmental factors may all affect print image quality. To ensure accuracy in determining the correctly matched candidate, the search record and the top “n” file records from the sorted list are provided to an examiner for manual review and inspection. Once a true match is found, the identification information is provided to a user and the search print record is typically discarded from the identification system. If a true match is not found, a new record is created and the personal information and print features of the search record are saved as a new file record into the database.

Manual review and verification is time consuming and directly relates to the cost of an AFIS daily operation. It is not unusual for a large AFIS system to conduct more than several thousands or tens of thousands of searches a day. If the top five match candidates are required to be manually viewed by the examiner for a single search, this corresponds to more than tens of thousands of records per day needing to be reviewed by an examiner. If one examiner can review one thousand candidate records per day, more than ten examiners are needed to review all the candidate records required for manual review. Accordingly, the cost of maintaining such a system that requires a fixed number of candidate records for manual review is high.

To reduce the cost, a “lights out” AFIS system has been designed to provide a dynamic number of candidates for an examiner to review in order to reduce the overall number of candidates requiring examiner review. Such a lights out system contains an intelligent decision logic to make a decision regarding whether a candidate is a strong match, a possible (or weak) match or no match. In this system, only possible matches are required to be reviewed by examiners. In some implementations, this reduces the number of candidate records for manual review from more than tens of thousands per day down to around a thousand per day as compared to the previously described system. The daily operation cost of a lights out system is, thereby, greatly reduced. However there is a tradeoff in the lights out system. More particularly, some declared “no match” candidates that should be reviewed by an examiner will be missed in the new lights out system. A way to address this shortcoming is by improving the accuracy of the matcher system by improving the match scores output by the system and used as input to the decision logic.

A number of solutions have been developed to improve match scores and to reduce the workload of manual examiners by, for example: attempting to obtain higher quality print images in the enrollment stage; attempting to design better quality sensors; using an image display to provide visual guidance while a user's images are being enrolled; having the user put his or her finger in different positions while capturing each fingerprint during the verification stage; using multiple impressions of the user's fingers to improve the accuracy; attempting to improve pre-processing to obtain better features and to improve matching algorithms to better distinguish a matching print from a non-matching print; and attempting to design better decision logic to reduce the number of candidates that a fingerprint examiner would subsequently review.

However, as the demand for and use of biometric identification systems continues to increase, there continues to be a need for solutions that limit the number of candidates requiring examiner review, while still maintaining system accuracy and decreased system costs.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 illustrates a block diagram of an AFIS implementing some embodiments.

FIG. 2 is a flow diagram illustrating a method in accordance with some embodiments.

FIG. 3 illustrates distribution curves for a print identification system prior to implementing some embodiments.

FIG. 4 illustrates distribution curves for a print identification system after implementing some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a primary sorted match report (generated during a first round of matcher processing) is modified based on match scores contained in one or more sub-match reports (generated during one or more iterative rounds of matcher processing and decision logic). Some sub-match reports are generated from taking each print in the primary match report that is identified using the decision logic as a strong match, comparing the strong match as a secondary search print to the other prints in the primary match report that were identified using the decision logic as a possible match or as no match, and reapplying the decision logic to generate a sub-match report. Moreover, if one or more strong matches are detected in the sub-match reports, these prints are used as a secondary search print to generate additional sub-match reports and the process iteratively performed until no additional strong match candidates are detected in the sub-match reports.

Strong match candidates from the primary match report have their scores enhanced by the highest score for that candidate found in the sub-match reports. No match candidates from the primary match report have their scores reduced by the lowest score for that candidate found in the sub-match reports. Possible match candidates from the primary match report have their scores modified by the highest score for that candidate found in the sub-match reports or by an average score for that candidate from the sub-match reports. Accordingly, the non-matching candidate scores will be reduced and the strong and possible match scores are enhanced so that the gap scores between the matching candidates to the non-matching candidates are increased. Moreover, the true mates initially detected as possible matches or the true mates initially detected as non-matching candidates may be promoted to strong or possible matches in a final sorted match report, by using the strong match candidates as search prints.

In this manner, false rejection rate (FRR) and false acceptance rate (FAR) can be improved in a biometric identification system for any selected threshold. Those skilled in the art will realize that the above recognized advantages and other advantages described herein are merely illustrative and are not meant to be a complete rendering of all of the advantages of the various embodiments.

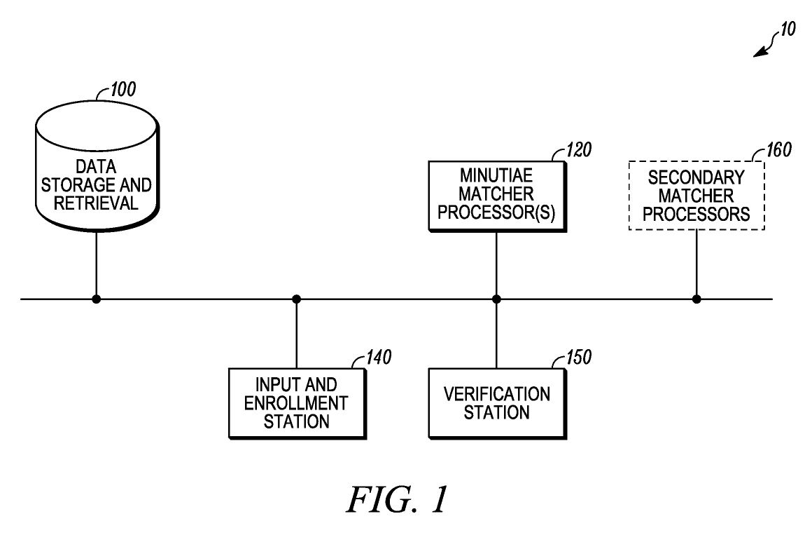

Referring now to the drawings, and in particular FIG. 1, a logical block diagram of an illustrative fingerprint matching system implementing some embodiments is shown and indicated generally at 100. Although fingerprints and fingerprint matching is specifically referred to herein, those of ordinary skill in the art will recognize and appreciate that the specifics of this illustrative example are not specifics of the invention itself and that the teachings set forth herein are applicable in a variety of alternative settings. For example, since the teachings described do not depend on the type of print being analyzed, they can be applied to any type of print (or print image), such as toe and palm prints (images). As such, other alternative implementations of using different types of prints are contemplated and are within the scope of the various teachings described herein.

System 100 is generally known in the art as an Automatic Fingerprint Identification System or (AFIS) as it is configured to automatically (typically using a combination of hardware and software) compare a given search print record (for example a record that includes an unidentified latent print image or a known ten-print) to a database of file print records (e.g., that contain ten-print records of known persons) and identify one or more candidate file print records that match the search print record. The ideal goal of the matching process is to identify, with a predetermined amount of certainty and without a manual visual comparison, the search print as having come from a person who has print image(s) stored in the database. At a minimum, AFIS system designers and manufactures desire to significantly limit the time spent in a manual comparison of the search print image to candidate file print images (also referred to in the art as respondent file print images).

Before describing system 100 in detail, it will be useful to define terms that are used herein and with regards to print matching.

A print is a pattern of friction ridges (also referred to in the art as “ridges”), which are raised portions of skin, and valleys between the ridges on the surface of a finger (fingerprint), toe (toe print) or palm (palm print), for example.

A print image is a visual representation of a print that is stored in electronic form.

A gray scale image is a data matrix that uses values, such as pixel values at corresponding pixel locations in the matrix, to represent intensities of gray within some range. An example of a range of gray-level values is 0 to 255.

Image binarization is the process of converting a gray-scale image into a “binary” or a black and white image. A thin image is a binary image that is one pixel wide. A wide binary image is a binary image that preserves at least the shape and width of ridges and the shape of pores.

A minutiae point or minutiae is a small detail in the print pattern and refers to the various ways that ridges can be discontinuous. Examples of minutiae are a ridge termination or ridge ending where a ridge suddenly comes to an end and a ridge bifurcation where one ridge splits into two ridges.

A similarity measure is any measure (also referred to herein interchangeably with the term score) that identifies or indicates similarity of a file print (or record) to a search print (or record) based on one or more given parameters.

A direction field (also known in the art and referred to herein as a direction image) is an image indicating the direction the friction ridges point to at a specific image location. The direction field can be pixel-based, thereby, having the same dimensionality as the original fingerprint image. It can also be block-based through majority voting or averaging in local blocks of pixel-based direction field to save computation and/or improve resistance to noise. A number of methods exist to determine direction and smooth direction images.

A direction field measure or value is the direction assigned to a point (e.g., a pixel location) or block on the direction field image and can be represented, for example, as a slit sum direction, an angle or a unit vector.

A pseudo-ridge is the continuous tracing of direction field points, where for each point in the pseudo-ridge, the tracing is performed in the way that the next pseudo-ridge point is always the non-traced point with smallest direction change with respect to the current point or the several previous points.

A singularity point is a core or a delta.

In a fingerprint pattern, a core is the approximate center of the fingerprint pattern on the most inner recurve where the direction field curvature reaches the maximum.

According to ANSI-INCITS-378-2004 standard, a delta is the point on a ridge at or nearest to the point of divergence of two type lines, and located at or directly in front of the point of divergence.

Level-three features are defined for fingerprint images, for example, relative to level-one and level-two features. Level-one features are the features of the macro-scale, including cores/deltas. Level-two features are the features in more detail, including minutiae location, angles, ridge length and ridge count. Level-three features are of the micro-scale, including pores, ridge shape, ridge gray level distribution and incipient ridges. In comparison to level-one and level-two features which are widely available in current fingerprint images, level-three features are most reliably seen in high resolution, e.g., >1000 ppi (pixels per inch) images.

Aligning two images (e.g., print images and/or direction images) includes positioning, e.g., by rotating and translating, the two images in relation to one another. Aligning can be done based on mated minutiae, wherein the two images are aligned such that there are a maximum number of mated minutiae detected between the images. Other alignment methods may be used in addition to or alternatively to mated minutiae alignment, such as alignment based on cores and/or deltas, which is well known in the art, and therefore not discussed in detail here for the sake of brevity.

A decision logic is used in a biometric identification system to identify a print (or record) as being a strong match, a possible (weak) match or no match based on a match score generated by one or more matcher processors for that print (record).

A file print (record) is identified as a strong match when it has a corresponding match score that is greater than a highest non-matching score from a non-matching distribution curve generated from a biometric identification system, which also generated the file print's (record's) match score.

A file print (record) is identified as a possible match when it has a corresponding match score that is between two score thresholds, wherein at least one of the two thresholds is lower that the highest non-matching score.

A file print (record) is identified as no match when it has a corresponding match score that is below the two thresholds used to identify a possible match.

A match report is a list of candidates (prints or records depending on the search being implemented), which are sorted according to their match scores usually, but not necessarily, in descending order.

Turning again to FIG. 1, an AFIS that may be used to implement the various embodiments of the present invention described herein is shown and indicated generally at 10. System 10 includes an input and enrollment station 140, a data storage and retrieval device 100, one or more minutiae matcher processors 120, a verification station 150 and optionally one or more secondary matcher processors 160. Embodiments may be implemented in one or more of the verification station 150 and the secondary matcher processor(s) 160, which in turn can be implemented using one or more suitable processing devices, examples of which are listed below.

Input and enrollment station 140 is used to capture fingerprint images to extract the relevant features (minutiae, cores, deltas, binary image, ridge features, etc.) of those image(s) to generate file records and a search record for later comparison to the file records. Thus, input and enrollment station 140 may be coupled to a suitable sensor for capturing the fingerprint images or to a scanning device for capturing a latent fingerprint.

Data storage and retrieval device 100 may be implemented using any suitable storage device such as a database, RAM (random access memory), ROM (read-only memory), etc., for facilitating the AFIS functionality. Data storage and retrieval device 100, for example, stores and retrieves the file records, including the extracted features, and may also store and retrieve other data useful to carry out embodiments of the present invention. Minutiae matcher processors 120 compare the extracted minutiae of two fingerprint images to determine similarity. Minutiae matcher processors 120 output to the secondary matcher processors 160 at least one set of mated minutiae corresponding to a list of ranked candidate records associated with minutiae matcher similarity scores above some threshold. Secondary matcher processors 160 provide for more detailed decision logic using the mated minutiae and usually some additional features to output either a sure match (of the search record with one or more print records) or a list of candidate records for manual comparison by an examiner to the search record to verify matching results using the verification station 150.

It is appreciated by those of ordinary skill in the art that although input and enrollment station 140 and verification station 150 are shown as separate functional boxes in system 10, these two stations may be implemented in a product as separate physical stations (in accordance with what is illustrated in FIG. 1) or combined into one physical station in an alternative embodiment. Moreover, where system 10 is used to compare one search record for a given person to an extremely large database of file records for different persons, system 10 may optionally include a distributed matcher controller (not shown), which may include a processor configured to more efficiently coordinate the more complicated or time consuming matching processes.

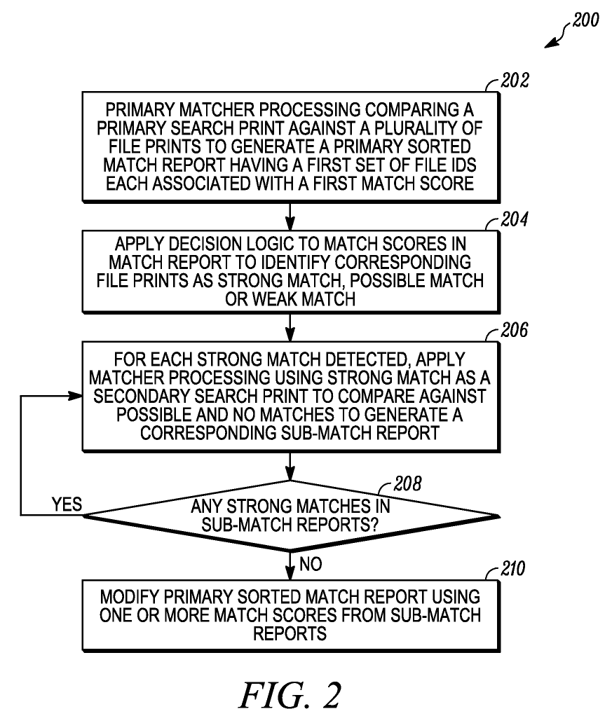

Turning now to FIG. 2, a flow diagram illustrating a method in accordance with some embodiments is shown and generally indicated at 200. In this illustrative implementation, method 200 is described in terms of a fingerprint identification process (such as one implemented in the AFIS shown in FIG. 1) for ease of illustration. However, it is appreciated that the method may be similarly implemented in biometric image identification for other types of prints such as, for instance, palm prints or toe prints without loss of generality, which are also contemplated within the meaning of the terms “print” and “fingerprint” as used in the various teachings described herein. Thus, all types of prints and images are contemplated within the meaning of the terms “print” and “fingerprint” as used in the various teachings described herein.

In general, method 200 comprises: for each of a plurality of file records each comprising at least a file print and a file identification (ID) identifying the file print, comparing (202) a primary search print that is included in a primary search record to the file print to generate a primary sorted match report comprising a first set of file IDs each associated with a first match score, wherein the file IDs in the first set are sorted based on the first match scores; applying (204) a decision logic to the match scores in the match report to determine a status of the corresponding file prints as being one of a strong match, a possible match or no match to the search print; for each file print identified as a strong match, using (206) the file print as a secondary search print to compare against file prints identified as a possible match or no match to generate a sub-match report comprising at least a portion of the first set of file IDs each associated with a second match score; and modifying (210) the primary sorted match report based on at least one of the second match scores to generate a final sorted match report comprising the first set of file IDs each associated with a final match score.

In addition, the decision logic can be applied to the generated sub-match reports to determine (208) existence of any strong matches in the sub-match reports, and steps 206 and 208 can be iteratively performed until no additional strong matches are identified. At that point, the primary sorted match report is modified using the one or more second match scores from the sub-match reports to generate the final sorted match report.

It should be noted that method 200 is described in terms of comparing print images, generating matching scores for a print image and identifying a print image as a strong match, a possible match and no match; for instance, as in print matching using a latent print as the primary search print. However, the method can be applied without loss of generality to print comparison at the record level (an in ten-print to ten-print matching), wherein match scores can be generated at the record level and records can be identified as a strong match, a possible match and no match, as is well known in the art. Thus, in an implementation using record level matching, use of the term “print” in the claims and as described herein encompasses the term “record”, and the terms are used interchangeably as appropriate.

Illustrative details for implementing method 200 will next be described. At 202, the search and file print records are received using any suitable interface within or into the system, and any one or more suitable matcher processors can be used to compare the primary search print to each file print to generate the primary sorted match report. For example, the primary search record can be obtained from the input and enrollment station 140. The file records can be obtained from data storage and retrieval 100. The primary sorted match report comprising the first set of file IDs can be generated by a minutiae matcher process performed in matcher processors 120, which compares a set of minutiae identified in the primary search print to a set of minutiae identified in each of the plurality of file prints. In another implementation, the sorted match report comprising the first set of file IDs is generated as the output of secondary matcher process performed in matcher processors 160 that uses output results generated from the minutiae matcher process to compare the primary search print to file prints from at least a portion of the plurality of file records.

At 204, the decision logic that is applied to the match scores in the primary sorted match report (and to the match scores in the sub-match reports where steps 206 and 208 are iteratively performed) to identify the corresponding prints as a strong match, a possible match or no match can be any suitable decision logic. For example, a fixed decision logic can be used that makes its determinations by comparing the match scores to a plurality of thresholds. An example implementation that uses a fixed decision logic is described in detail later. In many systems, however, a more complex decision logic is used, especially where ten-print to ten-print searches are performed. More illustrative detail regarding generating the sub-matched reports (at 206) is also explained by reference to the example implementation.

At 210, a set of rules can be used to modify one or more of the first match scores in the primary search report using at least one of the second match scores from one or more (and in one embodiment all) of the generated sub-match reports. As an illustrative example, the set of rules comprise: for at least one file ID with the status of its corresponding file print determined as a no match in the primary match report and in all of the generated sub-match reports, replacing the associated first match score with a lowest second match score for that file ID from the generated sub-match reports; for at least one file ID in any one of the primary match report and the generated sub-match reports with the status of its corresponding file print determined as a strong match, replacing the associated first match score with a highest second match score for that file ID from the generated sub-match reports; and for at least one file ID in any one of the primary search report and the generated sub-match reports with the status of its corresponding file print determined as a possible match, replacing the associated first match score with a highest second match score for that file ID from the generated sub-match reports or with an average of the match scores for that file ID from the primary match report and all of the generated sub-match reports. With respect to the rule for dealing with possible match detections, whether the match score for that file ID in the primary search report is replaced with the highest match score for that file ID or with an average match score for that file ID depends on accuracy requirements for the print matcher system. Use of the average score may be slightly more computationally intensive but generally leads to better accuracy when the final match report is used for ROC calculation, Application of embodiments enhances the accuracy of a print identification system by affecting the TAR and FRR of the system. False acceptance rate (FAR) and false rejection rate (FRR) are defined based on distribution curves generated using a given print identification system and a system threshold t used for determining whether two prints belong to the same finger. The threshold t can be selected based on a level of security desired for the system, wherein more secure systems have a higher system threshold. More particularly, pairs of fingerprints generating scores higher than or equal to t are inferred as matching pairs (i.e., belonging to the same finger), and pairs of fingerprints generating scores lower than t are inferred as non-matching pairs (i.e., belonging to different fingers). A typical biometric verification system commits two types of errors: mistaking biometric measurements from two different fingers to be from the same finger (called false match or false acceptance rate (FAR)), and mistaking two biometric measurements from the same finger to be from two different fingers (called false non-match or false rejection rate (FRR)).

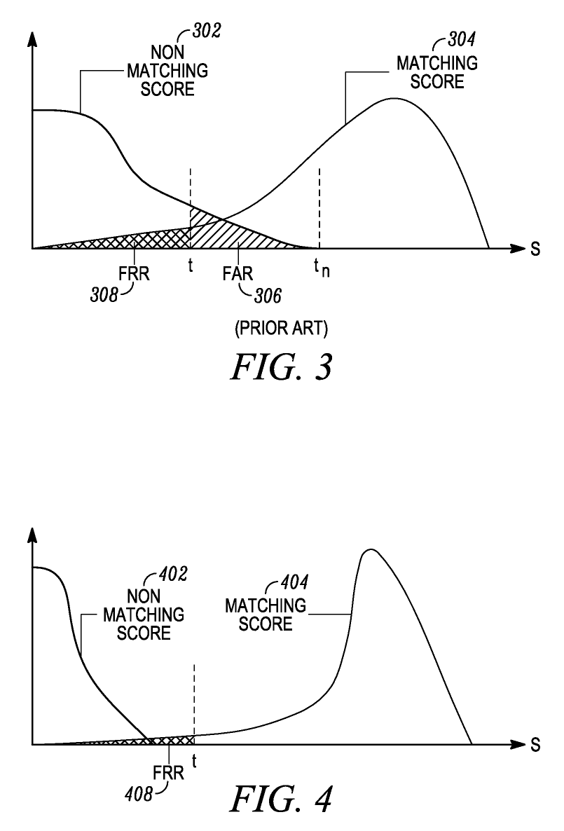

FIG. 3 illustrates two distribution curves 302 and 304 and a selected biometric identification system threshold t upon which a FAR 306 and a FRR 308 for the system are determined. Curve 302 is a non-matching minutiae matcher score (S) distribution curve for the biometric identification system, which can be generated from a number of fingerprint pairs from different fingers. Curve 304 is a matching score distribution curve, which can be generated from a number of fingerprint pairs from the same finger. The FAR 306 represents the percentage of false match pairs whose matching score is greater than or equal to t. The FRR 308 represents those true match fingerprint pairs that have a matching score that is less than t.

As can be seen from curves 302 and 304, there is a strict tradeoff between FAR and FRR in a biometric identification system, and both are a function of the system threshold t. Thus, normally if t is decreased to make the system more tolerant with respect to input variance and noise, then the FAR increases. Vice versa, if t is increased to make the system more secure, then the FRR increases. However, using embodiments in accordance with the teachings herein, true non-match scores can be reduced and possible and strong match scores increased to reshape and/or shift one or both of the distribution curves (see non-matching score curve 402 and matching score curve 404 as shown in FIG. 4) to improve both the FAR and the FRR without changing the system threshold. In this particular case, the FAR is eliminated, and the FRR (e.g., 408) is significantly improved.

To better understand the teachings herein, an example implementation is described. Let us assume that the primary search record includes a primary search print associated with a search ID s 199801, and that there are eight file records each containing a mated file print (that was enrolled from the same finger as the search print but at different times) in the system database.

Each mated file print has a corresponding file ID. These mated file print IDs are:

1 f000010
2 f100092
3 f203183
4 f010011
5 f389324
6 f023982
7 f499657
8 f024987

For simplicity we assume that a fixed decision logic using three thresholds T1, T2 and Tg has been pre-designed. Thresholds T1 and T2 are match score thresholds, wherein T1 is, for instance, the highest non-matching score for the non-matching distribution curve for the AFIS (e.g., tₕ shown in FIG. 3 is a highest non-matching score) and T2 is a score value that is less than T1. The other threshold Tg represents the value of a gap between an adjacent neighbor score. In this implementation T1 is 35, and T2 and Tg are, respectively, selected to be 25 and 18. Selection of the T2 value is based on both the matching and non-matching score distribution (or a ROC curve) of the matcher and the accuracy requirement of the matcher system. Based on the matcher accuracy, one can go to the ROC plot to find T2. In a similar fashion, Tg can be found on the ROC plot based on the accuracy requirement, from a gap score distribution of a gap score of matching versus non-matching prints. To ensure that the system is designed to meet the accuracy requirement, the selected T2 and Tg values can be further modified based on experiments of using the designed logic (with the selected thresholds) on predetermined datasets. Accordingly, the decision logic is as follows: if a Score>T1, the candidate is considered as a strong match; if a Score >T2 and the Score<T1, the candidate is considered as a possible match; if adjacent neighbor score threshold>Tg, the candidates other than the previously detected strong match above the gap are considered as a possible match; and all other candidates are no match.

For the search print identified by ID s 199801, assume a primary sorted match report of the top 20 candidates from a matcher process. Using the above three threshold decision logic, the decision results from the primary sorted match report are as follows:

Match report 1:
Search ID: s199801

| | ID | Score | Decision Results | Examiner Review |
|---|---|---|---|---|
| 1 | f000010 | 80 | Strong match | No |
| 2 | f100092 | 46 | Strong match | No |
| 3 | f203183 | 34 | Possible match | Yes |
| 4 | f010011 | 26 | Possible match | Yes |
| 5 | f389324 | 24 | No match | No |
| 6 | f023982 | 10 | No match | No |
| 7 | f091397 | 10 | No match | No |
| 8 | f010003 | 9 | No match | No |
| 9 | f010332 | 9 | No match | No |
| 10 | f389756 | 9 | No match | No |
| 11 | f012795 | 8 | No match | No |
| 12 | f031499 | 8 | No match | No |
| 13 | f052214 | 8 | No match | No |
| 14 | f225918 | 8 | No match | No |
| 15 | f320533 | 8 | No match | No |
| 16 | f499657 | 7 | No match | No |
| 17 | f122896 | 7 | No match | No |
| 18 | f141594 | 7 | No match | No |
| 19 | f262318 | 7 | No match | No |
| 20 | f139998 | 7 | No match | No |

If this is a lights out system, there would only be two candidates requiring examiner review (i.e., the file print having ID f203183 and the file print having ID f010011). However, a prior art system that outputs match report 1 would, thus, only identify four of the eight mated prints, with only two of these identified prints being sure matches (strong matches). Embodiments of the teachings herein using the same decision logic and matcher process will now be applied to the above primary sorted match report to generate a final sorted match report.

After applying the decision logic, as shown in match report 1 two strong matches and two possible matches are identified. Each of the two strong identified candidates is compared to (or searched against) the possible match and no match candidates having a lower score. For example, f000010 searches against the numbered 3 to 20 fingerprints in the match report 1 to create unsorted sub-match report 1, f100092 searches against the numbered 3 to 20 fingerprints in the match report 1 to create unsorted sub-match report 2. These two sub-match reports are sorted and examined by the decision logic. Two strong matches: f203183 and f023982; and two possible matches: f499657 and f389324 are detected in the sub-match report 2. These two additional strong matches are, respectively, matched against the rest of the non-strong match candidates to create two more sub-match reports 3 and 4. Since no more strong matches are detected in the sub-match reports 3 and 4, no additional matcher processing and decision is required.

| | | Sub-match | Sub-match | Sub-match | Sub-match |
|---|---|---|---|---|---|
| | | Rpt1 | Rpt2 | Rpt3 | Rpt4 |
| | | Search ID | | | |
| | | f000010 | f100092 | f203183 | f023982 |
| | ID | Score1 | Score2 | Score3 | Score4 |
| 1 | f000010 | | | | |
| 2 | f100092 | | | | |
| 3 | f203183 | 33 | 36 | | |
| 4 | f010011 | 24 | 23 | 28 | 23 |
| 5 | f389324 | 21 | 26 | 32 | 18 |
| 6 | f023982 | 38 | | | |
| 7 | f091397 | 3 | 4 | 0 | 3 |
| 8 | f010003 | 6 | 0 | 4 | 7 |
| 9 | f010332 | 3 | 0 | 3 | 1 |
| 10 | f389756 | 2 | 6 | 0 | 8 |
| 11 | f012795 | 1 | 5 | 2 | 9 |
| 12 | f031499 | 2 | 7 | 10 | 8 |
| 13 | f052214 | 12 | 9 | 2 | 3 |
| 14 | f225918 | 2 | 0 | 6 | 11 |
| 15 | f320533 | 1 | 4 | 9 | 6 |
| 16 | f499657 | 10 | 26 | 0 | 19 |
| 17 | f122896 | 5 | 4 | 2 | 0 |
| 18 | f141594 | 8 | 1 | 4 | 5 |
| 19 | f262318 | 3 | 2 | 6 | 2 |
| 20 | f139998 | 2 | 0 | 3 | 4 |

Since the matching and application of the decision is complete, the rules can be applied to modify at least one score in match report 1 using at least one score in the sub-match reports 1, 2, 3 and 4. The rules can be applied in any suitable order, and any such order is contemplated within the scope of the teachings herein. One way to modify the scores in match report 1 in accordance with the teachings is as follows. Each candidate identified as no match (i.e., candidates numbered 5 to 20 of match report 1) has its score modified by a lowest (minimum) score for that corresponding file ID in any of the four sub-match reports to create a new score list as the match report 2. For example, the minimum score of the number 8 candidate f010003 is 0. By performing this process, most of the non-matching scores are reduced. However, the scores are also undesirably reduced for some file IDs (e.g., f389324 and f023982) having corresponding file prints identified in a sub-match report (e.g., respectively sub-match reports 2 and 1) as a mated print (e.g., a strong match or a possible match).

Match report 2:
Search ID: s199801

| | ID | Score | Decision Results | Examiner Review |
|---|---|---|---|---|
| 1 | f000010 | 80 | Strong match | No |
| 2 | f100092 | 46 | Strong match | No |
| 3 | f203183 | 34 | Possible match | Yes |
| 4 | f010011 | 26 | Possible match | Yes |
| 5 | f389324 | 18 | No match | No |
| 6 | f023982 | 8 | No match | No |
| 7 | f091397 | 0 | No match | No |
| 8 | f010003 | 0 | No match | No |
| 9 | f010332 | 0 | No match | No |
| 10 | f389756 | 0 | No match | No |
| 11 | f012795 | 1 | No match | No |
| 12 | f031499 | 2 | No match | No |
| 13 | f052214 | 2 | No match | No |
| 14 | f225918 | 0 | No match | No |
| 15 | f320533 | 1 | No match | No |
| 16 | f499657 | 0 | No match | No |
| 17 | f122896 | 0 | No match | No |
| 18 | f141594 | 1 | No match | No |
| 19 | f262318 | 2 | No match | No |
| 20 | f139998 | 0 | No match | No |

To overcome the above-mentioned undesirable effect to some mated scores, the following two step process is taken. Step 1 is to find each file ID whose corresponding file print has a score identifying it as a no match in match report 2 and that also has a score identifying it as a strong match in one of the sub-match reports, and replace the no match score with the strong match score for that file ID. Step 2 is to find each file ID whose corresponding file print has a score identifying it as a no match in match report 2 and that also has a score identifying it as a possible match in one of the sub-match reports, and replace the no match score with an average score for that file ID. The average score is calculated by adding the candidate's corresponding score in the sub-match reports 1 to 4 and in the original match report 1 and divide by the total number of added entries. Match report 3 shows the score changes after this two step process.

Match report 3:
Search ID: s199801

| | ID | Score | Decision results |
|---|---|---|---|
| 1 | f000010 | 80 | Strong match |
| 2 | f100092 | 46 | Strong match |
| 3 | f203183 | 36 | Strong match |
| 4 | f010011 | (26 + 24 + 23 + 28 + 23)/4 = 25 | Possible match |
| 5 | f389324 | (24 + 21 + 26 + 32 + 18)/5 = 24 | Possible match |
| 6 | f023982 | 38 | Strong match |
| 7 | f091397 | 0 | |
| 8 | f010003 | 0 | |
| 9 | f010332 | 0 | |
| 10 | f389756 | 0 | |
| 11 | f012795 | 1 | |
| 12 | f031499 | 2 | |
| 13 | f052214 | 2 | |
| 14 | f225918 | 0 | |
| 15 | f320533 | 1 | |
| 16 | f499657 | (7 + 10 + 26 + 0 + 19)/5 = 12 | Possible match |
| 17 | f122896 | 0 | |
| 18 | f141594 | 1 | |
| 19 | f262318 | 2 | |
| 20 | f139998 | 0 | |

Match report 4 shows the sorted final match report. The decision logic can be applied to match report 4 again to check whether any new candidates are detected as a match. In this case, no new candidates are detected.

Match report 4:
Search ID: s199801

| | ID | Score | Decision results | Examiner review |
|---|---|---|---|---|
| 1 | f000010 | 80 | Strong match | No |
| 2 | f100092 | 56 | Strong match | No |
| 3 | f023982 | 38 | Strong match | No |
| 4 | f203183 | 36 | Strong match | No |
| 5 | f010011 | 25 | Possible match | Yes |
| 6 | f389324 | 24 | Possible match | Yes |
| 7 | f499657 | 12 | Possible match | Yes |
| 8 | f031499 | 2 | No match | No |
| 9 | f052214 | 2 | No match | No |
| 10 | f262318 | 2 | No match | No |
| 11 | f012795 | 1 | No match | No |
| 12 | f320533 | 1 | No match | No |
| 13 | f141594 | 1 | No match | No |
| 14 | f091397 | 0 | No match | No |
| 15 | f010003 | 0 | No match | No |
| 16 | f010332 | 0 | No match | No |
| 17 | f389756 | 0 | No match | No |
| 18 | f225918 | 0 | No match | No |
| 19 | f122896 | 0 | No match | No |
| 20 | f139998 | 0 | No match | No |

The above illustrative example shows one implementation of applying the rules to modify a primary sorted match report. Other implementations are within the scope of the teachings herein. For example, one simpler implementation to obtain match report 3 in accordance with the teachings herein is as follows. All of the candidates having a strong match and a possible match in all match reports (including match report 1 and all four sub-match reports) are found. The score of each strong match candidate in match report 1 is replaced by its corresponding highest match score of the same file ID from all generated sub-match reports. The score of each possible match candidate in match report 1 is replaced by its corresponding highest match score of the same file ID from all generated sub-match reports or by the average score of its corresponding match scores of the same file ID from all generated match reports. The score of each other candidate, which is not identified as a strong or a possible match in any of the generated sub-match reports, is replaced by the minimum score of the same file ID from all generated sub-match reports.

In the current invention, the total numbers of mated identifications is 7, and this search requires 3 reviews. If the possible matches are discounted, the numbers of identifications are 4. This means a system with such an implementation can save operation cost. If only two reviews are applied to the search case, the total number of identifications is 6. So the embodiments can improve the accuracy while maintaining the same operation cost.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for iterative print matching described herein. The non-processor circuits may include, but are not limited to, a radio receiver, a radio transmitter, signal drivers, clock circuits, power source circuits, and user input devices. As such, these functions may be interpreted as steps of a method to perform the iterative print matching described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage medium having computer readable code stored thereon for programming a computer (e.g., comprising a processing device) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
for each of a plurality of file records each comprising at least a file print and a file identification (ID) identifying the file print, comparing a primary search print that is included in a primary search record to the file print to generate a primary sorted match report comprising a first set of file IDs each associated with a first match score, wherein the file IDs in the first set are sorted based on the first match scores;
applying a decision logic to the match scores in the match report to determine a status of the corresponding file prints as being one of a strong match, a possible match or no match to the search print;
for each file print identified as a strong match, using the file print as a secondary search print to compare against file prints identified as a possible match or no match to generate a sub-match report comprising at least a portion of the first set of file IDs each associated with a second match score; and
modifying the primary sorted match report based on at least one of the second match scores to generate a final sorted match report comprising the first set of file IDs each associated with a final match score.

2. The method of claim 1, wherein comparing the primary search print to the file prints from the plurality of file records comprises at least one of:
a minutiae matcher process that, for each of the plurality of file records, compares a set of minutiae identified in the primary search print to a set of minutiae identified in the file print; and
a secondary matcher process that uses results generated from the minutiae matcher process to further compare the primary search print to file prints from at least a portion of the plurality of file records.

3. The method of claim 1 further comprising, before generating the final sorted match report, repeatedly applying the decision logic and using a file print having a status of a strong match as a secondary search print to generate a sub-match report until no file print having a strong match is identified in a subsequently generated sub-match report.

4. The method of claim 1, wherein modifying the primary sorted match report comprises, for at least one file ID with the status of its corresponding file print determined as a no match in the primary match report and in all of the generated sub-match reports, replacing the associated first match score with a lowest second match score for that file ID from the generated sub-match reports.

5. The method of claim 1, wherein modifying the primary sorted match report comprises, for at least one file ID in any one of the primary match report and the generated sub-match reports with the status of its corresponding file print determined as a strong match, replacing the associated first match score with a highest second match score for that file ID from the generated sub-match reports.

6. The method of claim 1, wherein modifying the primary sorted match report comprises, for at least one file ID in any one of the primary search report and the generated sub-match reports with the status of its corresponding file print determined as a possible match, replacing the associated first match score with a highest second match score for that file ID from the generated sub-match reports or with an average of the match scores for that file ID from the primary match report and all of the generated sub-match reports.

7. The method of claim 1, wherein the primary sorted match report is modified based on at least one second match score from each of the generated sub-match reports.

8. The method of claim 1, wherein a file print is identified as a strong match when it has a corresponding match score that is greater than a highest non-matching score from a non-matching distribution curve generated from a print identification system, which also generated the file print's match score.

9. The method of claim 8, wherein a file print is identified as a possible match when it has a corresponding match score that is between two score thresholds, wherein at least one of the two thresholds is lower that the highest non-matching score.

10. A print identification system comprising:
an interface receiving a plurality of file records each comprising at least a file print and a file identification (ID) identifying the file print and a primary search record comprising a primary search print; and
a processing device,
for each of the plurality of file records, comparing the primary search print to the file print to generate a primary sorted match report comprising a first set of file IDs each associated with a first match score, wherein the file IDs in the first set are sorted based on the first match scores;
applying a decision logic to the match scores in the match report to determine a status of the corresponding file prints as being one of a strong match, a possible match or no match to the search print;
for each file print identified as a strong match, using the file print as a secondary search print to compare against file prints identified as a possible match or no match to generate a sub-match report comprising at least a portion of the first set of file IDs each associated with a second match score;
repeatedly applying the decision logic and using a file print as a secondary search print to generate a sub-match report until no file print having a strong match is identified in a subsequently generated sub-match report; and
modifying the primary sorted match report based on at least one of the second match scores to generate a final sorted match report comprising the first set of file IDs each associated with a final match score.

11. The print identification system of claim 10, wherein the system is an Automatic Fingerprint Identification System (AFIS).

12. A computer-readable storage medium having computer readable code stored thereon for programming a computer to perform a method upon receiving a plurality of file records each comprising at least a file print and a file identification (ID) identifying the file print and a primary search record comprising a primary search print, the method comprising:
for each of the plurality of file records, comparing the primary search print to the file print to generate a primary sorted match report comprising a first set of file IDs each associated with a first match score, wherein the file IDs in the first set are sorted based on the first match scores;
applying a decision logic to the match scores in the match report to determine a status of the corresponding file prints as being one of a strong match, a possible match or no match to the search print;
for each file print identified as a strong match, using the file print as a secondary search print to compare against file prints identified as a possible match or no match to generate a sub-match report comprising at least a portion of the first set of file IDs each associated with a second match score; and
modifying the primary sorted match report based on at least one of the second match scores to generate a final sorted match report comprising the first set of file IDs each associated with a final match score.

13. The computer-readable storage medium of claim 12, wherein the method further comprises repeatedly applying the decision logic and using a file print having a status of a strong match as a secondary search print to generate a sub-match report until no file print having a strong match is identified in a subsequently generated sub-match report.

14. The computer-readable storage medium of claim 12, wherein the computer readable storage medium comprises at least one of a hard disk, a CD-ROM, an optical storage device, a magnetic storage device, a ROM (Read Only Memory), a PROM (Programmable Read Only Memory), a EPROM (Erasable Programmable Read Only Memory), a EEPROM (Electrically Erasable Programmable Read Only Memory) and a Flash memory.
